(19) United States
(12) Patent Application Publication
(10) Pub. No.: US 2010/0002857 A1
(43) Pub. Date: Jan. 7, 2010

(54) Addressing data loggers and telephones upon networks, including upon the PSTN, in parallel and in common in groups, with subsequent secondary addressing of devices uniquely

(76) Inventor: Renato Martinez Openiano, Chula Vista, CA (US)

Correspondence Address: William C. Fuess, Suite 2G, 10951 Sorrento Valley Road, San Diego, CA, 92121-1613, US

(21) Appl. No.: 12/214,510

(22) Filed: Jun. 18, 2008

Related U.S. Application Data
(60) Provisional application No. 60/936,027, filed on Jun. 18, 2007.
(60) Provisional application No. 60/961,339, filed on Jul. 21, 2007.
(60) Provisional application No. 60/936,912, filed on Jun. 22, 2007.

(51) Int. Cl. H04M 11/00

(52) U.S. Cl. 379/106.03

(57) ABSTRACT

The present invention contemplates improved addressing of, and retrieval of data from, unique addressable data loggers connected by and upon networks, including the Public Service Telephone Network (PSTN). Collection of data from the data loggers distributed upon the network to a data-collecting central, base, station is by (1) network broadcast of a primary address recognized by many, or even all, data loggers. Data loggers so primarily addressed thereafter later individually uniquely respond to (2) broadcast secondary addresses and/or directives, which may be encrypted, so as to (3) deliver up logged data to the base station.

### REFERENCE TO A RELATED APPLICATION

The present application is related to, and claims benefit of priority of, U.S. Provisional Patent applications Ser. No. 60/936,027 filed Jun. 18, 2007, for “Single phone linked to multiple phone data logger”; Ser. No. 60,961,339 filed Jul. 21, 2007, for “Added feature of remote phone data logger U.S. 60/936,027”; and Ser. No. 60/936,912 filed Aug. 8, 2007, for “Another added feature of remote phone data logger U.S. 60/936,027”. All provisional patent applications are in the name of the selfsame inventor of the present application.

### BACKGROUND OF THE INVENTION

1. Field of the Invention

The present invention generally concerns the addressing and reading of network-connected addressable data loggers and telephones, including data loggers and telephones connected by and upon the Public Service Telephone Network (PSTN).

The present invention particularly concerns demand reporting by each of a great multiplicity of network-connected data loggers/telephones where (1) groups of, most typically, multiple data loggers/telephones are first-addressed for communication in parallel and in common, followed by (2a) second-addressing, and optionally commanding, individual unique ones of the data loggers/telephones of the connected group.

2. Description of the Prior Art

2.1 General Requirement Circa 1990 for An Electronic Power Meter

The present invention concerns the addressing, and the reporting of information from, network-connected data loggers and telephones. The data loggers may be, for example,—but are not limited to be—electric utility usage meters. The network may be, for example, a wireless public service telephone (communications) network (the “PSTN”).

U.S. electrical utilities have desired for some time power meter features and capabilities that the traditional electro mechanical power meter cannot provide. However, these desires are only just of present, circa 2008, being considered sufficient so as to justify a complete one-for-one replacement of existing residential power meters.

Without the market scale which would be dictated only by wholesale replacement of existing residential power meters, electronic meters have been relegated to niche markets. Now (circa 2008), however, electrical utilities face the new requirement of wheeling. With the advent of Wheeling, utilities are willing to consider a complete replacement of the existing electro mechanical meters. More powerful electronic meter are now being produced at prices comparable to, or less than, the existing electro mechanical meter.

Utilities throughout the United States recognize that Wheeling is rapidly becoming a reality and the resulting competition will dictate the adoption and utilization of a new metering technology. Many new and interesting metering products are becoming available, but to date these products have targeted small niche markets. The price and longevity of the electro mechanical meters have prevented direct competition for the large residential market. However, wheeling [defined and further discussed in the fourth paragraph hereinafter] now provides the opportunity to upset this long-standing impasse.

The requirements for electric utility metering in the United States are driven by the customer. There is a general concern for customer satisfaction in the utility industry which is being driven to some degree, circa 2008, by the prospect of wheeling. The specific areas where utilities are interested in improving their customer interface are in offering (I) variable rates for load management, (ii) direct load curtailment, (iii) time of use (TOU) information, (iv) security, and revenue protection, (v) reduced expenses in meter reading, and (vi) customer interactive communications.

At the present time there appear to be an abundance of reasons for the U.S. utility industry to anticipate changes and prepare to operate competitively in a significantly different business environment. Some of the factors that contribute to the changes are include: (I) the present and long term United States economics trend of expansion, (ii) wheeling, (iii) electric vehicles, and (iv) new technology.

Detailed discourse regarding the US economy is beyond the scope of this disclosure. However, U.S. electric utilities have been seriously affected in the past by varying interest rates. Power generation expansion that requires borrowed capital can put a utility business at risk of failure.

Wheeling became a reality when the Public Utility Regulatory Policies Act of 1978 (PURPA) amended the Federal Power Act and gave the Federal Energy Regulatory Commission (FERC) expanded responsibilities for the encouragement of co-generation and small power production using alternative energy technologies. See Electric Power Wheeling and Dealing, Technological Considerations for increasing Competition; Congress of the United States Office of Technology Assessment PP 55. The goals of PURPA were to advance: 1) conservation of electric energy, 2) increased efficiency in electric power production, and 3) achievement of equitable retail rates for consumers. This was advanced in large part by requiring utilities to interconnect with and buy power from co-generators and small power producers that met standards established by FERC. This was the first major Federal move to open up electricity markets to non-utilities.

There have been other amendments to the Act of 1978 and all the utilities that were contacted in our market survey are preparing for the added competition that the act allows. In this relative new competitive environment, the energy will be billed to the utility that can provide the best service at the lowest cost. Better service can be accomplished by: 1) instantaneous readouts for shut-offs, turn-ons, verification, etc. 2) TOU (time of use) profiles which will allow rate change allowances, 3) faster and more accurate billing and 4) demand load control. Finally, the lower cost will result from: 1) manual meter reading elimination, 2) load leveling, and 3) improved customer relations.

Another government mandate that is destined to impact the utility industry is electric vehicles. Air pollution has prompted the State of California to establish quotas for non-polluting (electric) vehicles in the Los Angeles area. Not only will the use of electric vehicles increase the need for electrical energy, but a new metering concept will be required. At least one utility is currently buying communications equipment so that each electric vehicle can have it's own individual power meter. This allows the utility company to appropriately charge the vehicle owner irrespective of where the vehicle batteries are recharged. The magnitude of the added energy usage requirement is clearly brought into perspective in realizing that the energy requirements for an electric vehicle would about parallel the usage of a typical residence.

It is interesting and important to note that the new DRM system will exactly satisfy the electric vehicle metering requirements. A readout could be accomplished at any time when the vehicle is domiciled at a designated location. Alternatively a search and read program could be implemented to perform a readout anywhere in the utility service area.

A number of advancements in new technology can now provide the basis for a significantly different residential power meter. Microprocessors have been developed for large volume applications, particularly for the automotive industry, and RF integrated circuits have been developed for large volume application such as commercial radios, pagers and portable telephones. The large volume is the ingredient that dictates the economics, and these particular components are directly applicable to the power meter application.

2.1 Specific Objectives of the New Electronic Power Meters

The present invention will be seen not to concern an electronic power meter, per se, but rather the manner by which these, and still other networked data loggers, might effectively communicate upon any network, particularly including the Public Service Telephone Network, and still more particularly wireless versions of the public service telephone networks.

However, as background, it should be understood that the new increased-capability electronic power meters now coming into service are priced comparably to the existing residential electro mechanical power meters. However, their capabilities are greatly enhanced. These new capabilities typically include the following:

A new electronic power meter sometimes offers built-in two-way RF communications for automatic remote meter reading.

It typically retains hourly time-of-use (TOU) measurements, most typically for 30 days. Alternatively, a new meter can retain TOU measurements every 2½ minutes for 2 hours,

The new electronic power meter record the time of, and send an alarm, at the onset of any tampering so as to help preclude energy theft.

The new meters typically provide a display, sometimes remote, for customer communications.

Finally, these new electronic power meters sometimes provide output control for load curtailment.

The new electronic power meters typically have an operational life of at least 15 years with a failure rate of less than 1% per year, an normally much, much less. Electronic devices can easily achieve this stringent operational requirement. Each new electronic power meter is in particular be designed with proper derating and overall conservatism to guarantee the prescribed long life, target costs and performance.

2.3 Particular Challenges in Communication with Network-Connected Remote Data Loggers Including, by Way of Example, Electronic Power Meter

The present invention will be seen to address particular challenges in communication with network-connected remote data loggers including, by way of example, electronic power meters.

Communication, and, most often, wireless communication with these data logging devices is not per se difficult. When intended to function for demand reporting upon the public service telephone network, these devices function much like telephones, When possessed of but some, or even none, of (1) voice (sound), (2) keypad, and/or (3) screen display capabilities, they can be, and typically are, manufactured more inexpensively than are common telephones.

The challenge is not in making these data logger devices to communicate upon the Public Service Telephone Networks both wired and wireless, but in how they do so. Basically, when deployed in huge multiplicities—as is common—addressable connection(s) to the unique devices in aggregate takes (1) too much time (2) entailing too many individual connections for which (3) the communications carrier is wont to bill, and bill greatly. In simple terms, once the telephone company finds out that the power company is saving $10M per month by using remote reading of its electronic meters upon the telephone company's network, then the telephone company is likely to decide that it want $5M per month for its communications services!

For instance, as taught in U.S. Pat. No. 6,078,785 for “Demand reporting of electricity consumption by radio in relays to a base station, and demand relays wattmeters so reporting over a wide area”—itself an improvement to the reporting “log jam”—“[a] great number (typically over 1 million) radio-communicating monitors of electricity consumption (typically all-electronic computerized wattmeters) distributed over a large geographical area (typically over 4500 square miles) [ten] communicate over radio frequency band (typically VHF band at a one of three different frequencies) to multiple (typically over 45) regional central stations. Communication both to and from distant monitors . . . [can be via] multi-path multi-link radio through intervening monitors, commonly located each in an associated annular concentric ring centered about a regional central station. Individual monitors from 0 to typically 5.64 miles distance from regional central stations are individually interrogated of typically 25 bytes information in typically up to 5 relays both outgoing and incoming during a time interval of up to typically 9.78 seconds at data transfer rates of typically 6 kbaud/second. Some 1.2 million monitors, called “demand relay meters” can typically be read out in 55 hours. Any individual demand relay meter can be accessed for instantaneous electrical consumption, and well as a demand profile history, for load monitoring and for load-sensitive billing purposes.” And this performance is only after application of the considerably effective invention of the '785 patent.

Considering the same exemplary metrics as applied to retrieving information from great multiplicities of data loggers communicatively interconnected upon a public cellular communications network, the numbers are just as bad. If each communication with a data logger, or electrical meter, takes ten seconds from start to finish, and there exist one million such loggers as might be realistic for a metropolitan area, then about 115.8 days are required to canvas all loggers. Alternatively, some four telephone lines dialing 24 hours per day may be used for the entirety of each month.

So long as the cellular telephone company will allocate one million unique telephone numbers to the data loggers, and will charge only but a modest the unlimited usage rate for only but four cell phone numbers, then no problem is presented. However, the cellular telephone company may well and logically want to charge some access stipend for some million unique telephone numbers (if, indeed, such are even possible of allocation), making it a very expensive process indeed for an electric utility company to use the wireless PSTN to communicate with its distributed meters.

### SUMMARY OF THE INVENTION

The present invention contemplates improved the addressing of, and retrieval of data from, unique addressable data loggers connected by and upon networks, including the Public Service Telephone Network (PSTN). Collection of data from the data loggers distributed upon the network to a data-collecting central, base, station is by (1) network broadcast of a primary address that is recognized by many, or even all, data loggers/telephones. The Data loggers/telephones so primarily addressed are thereafter later individually uniquely addressed in and by broadcast of secondary addresses and/or directives. Thus the individually uniquely addressed and commanded data loggers/telephones deliver up logged data to the base station only when, and if, so individually uniquely addressed and commanded in both a primary, and aa secondary, addressing sequence.

For example, the communications method and system of the present invention may be deployed upon a network of a great number of geographically-distributed radio-communicating monitors of the use of electricity. These monitors, or data loggers, support cellular radio communications upon the wireless PSTN. They must communicate by cellular radio to a central station, upon and responsively to successive demands originating from this central station, such electricity usage as is monitored by each of the great number of monitors. This radio communication is typically multi-link and multi-path in accordance with the standard operation of the cellular telephone communications network. Each central stations typically covers a large geographic area encompassing many monitors. The central station desires to successively interrogate each monitors without interference. In accordance with the cellular telephone communications network, failed multi-path radio communications to non-responding monitors are automatically re-routed. Further, it is difficult to fraudulently emulate the legitimate reporting of a legitimate monitor for purpose of embezzling electricity.

1. The System of the Present Invention for Use in Collection of Data Remotely Distributed upon a Wireless Communications Network

In one of its aspects the present invention is embodied in a method of addressing, and retrieving data from, a multiplicity of addressable data loggers distributed on and connected by networks including the Public Service Telephone Network (PSTN), to a data-collecting central, base, station.

The method includes (1) broadcasting upon the network from the central station a primary address recognized by a plurality of network-connected data loggers; and thereafter (2) communicating upon the network from the central station secondary addresses sufficient to identify unique ones of the plurality of network-connected data loggers recognizing the primary address. The multiplicity of addressable data loggers are thus first primary-addressed and thereafter individually secondary-addressed so as to deliver up logged data to a data-collecting base station upon the network. Note that the multiplicity of data loggers need not equal in number the multiplicity of data loggers that are primary-addressed.

The communicating may optionally further include communicating upon the network commands sufficient to direct secondary-addressed unique ones of the plurality of primary-addressed network-connected data loggers.

The broadcasting may optionally include auto-dialing successively through a plurality of telephone numbers each of which numbers primary-addresses a corresponding plurality of the multiplicity of network-connected data loggers.

The broadcasting may optionally be of a primary address that is a toll telephone number.

The multiplicity of addressable data loggers may optionally have call screening, and be sensitive to be first primary-addressed only by a base station having a predetermined telephone number. The base station then primary-addresses the plurality of network-connected data loggers from this predetermined telephone number.

2. A System of Remote Data Collection upon a Telephone Network

In another of its aspects the present invention may be considered to be embodied in a system of remote data collection upon a telephone network.

The system includes (1) a multiplicity of data-collecting and data-transmitting phones upon a telephone network, where a plurality of these phones have, and are uniquely addressable by, an identical same primary phone number upon the telephone network, while all phones of the plurality have a unique secondary identification received upon the telephone network once a phone is communicatively connected thereto and thereon. Only, and each, such operative phone when both primary-addressed and secondary-addressed transmits collected data.

The system further includes (2) a base data-collecting phone collecting data from the multiplicity of remote data-transmitting phones by first broadcasting a primary phone number as serves to primary-address a plurality of phones, and then, second, successively communicating secondary identifications as successively serve to identify and to secondary-address unique phones of the primary-addressed plurality of phones. Then proceeds successively receiving data from each unique phone of the multiplicity of phones as it is both primary-addressed and successively-secondary-addressed.

This system may optionally be operated so that when a unique phone both primary-addressed and secondary-addressed is inoperative to transmit collected data then the base data-collecting phone does in succession communicate secondary identification to a next successive phone of the primary-addressed plurality.

In this system at least one of the multiplicity of data-collecting and data-transmitting phones may be located accessible to an owner/operator of the base data-collecting phone without involvement any party controlling premises where are located the at least one data-collecting and data-transmitting phone.

3. Uses of the Present Invention

The data collection system and method of the present invention may be used for diverse business purposes, such as networked electronic reporting electricity usage meters, and monitors o/f vending machine inventory,

Likewise, the remote data collection system and method of the present invention may be used for the collection of diverse data for diverse purposes, such as weather, seismic and traffic data.

4. Still Further Aspects of the Present Invention

In another aspect of the data addressing system and method of the present invention for the transmission of data on a network between, most typically, a great multiplicity of distributed data-transmitting phones and but a few, ro one, data-receiving base phone, the great multiplicity of remote data-transmitting phones having a same identical (primary) phone number can enjoy a common toll number, such as 1-900 number. Because a caller will have to pay a toll for calling this number, unwanted calls can be minimized.

Still further, communications received from the multiplicity of remote data-transmitting phones can be filtered in and through a call screener that serves to screen all incoming calls for any pre-selected criteria. These criteria include, but are not limited to a) caller ID compliance, and b) not being included among black-listed callers. This call screener feature of the system and of the multiple data-logger phones is most preferably remotely programmable and re-programmable by the system owner/operator—as well as being capable of in-field programmable by the field technician. The system owner/operator is thus the entity that operates the entire system, and not the individual consumer,

Still further, at least one of the multiple data-logging phones is preferably located in an owner/operator easily accessible location, such as inside the owner/operator operation room/monitoring room, and other than being located out in a field. This then simplifies easy monitoring and sample testing by the system owner/operator.

These and other aspects and attributes of the present invention will become increasingly clear upon reference to the following specification and accompanying drawings.

### BRIEF DESCRIPTION OF THE DRAWINGS

FIG. I is a diagrammatic representation depicting communication via the Primary System Remote Phones Data Transmitters

FIG. 2 is a diagrammatic representation depicting communication via the Secondary System Remote Phones Data Transmitters

FIG. 3, consisting of FIGS. 2a and 3b, is a flow chart of the operation of the addressing method of the present invention.

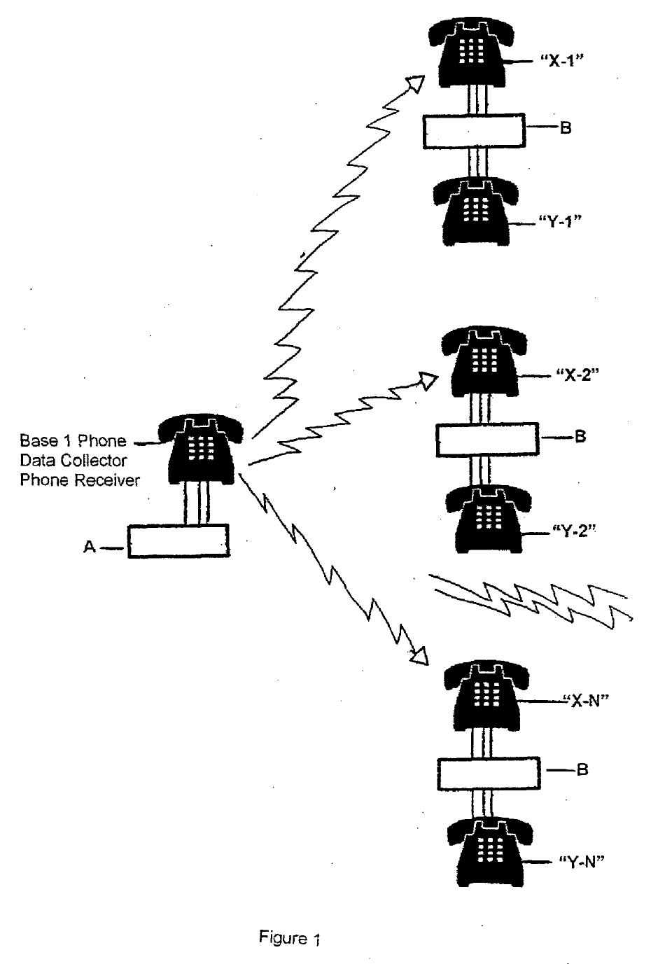

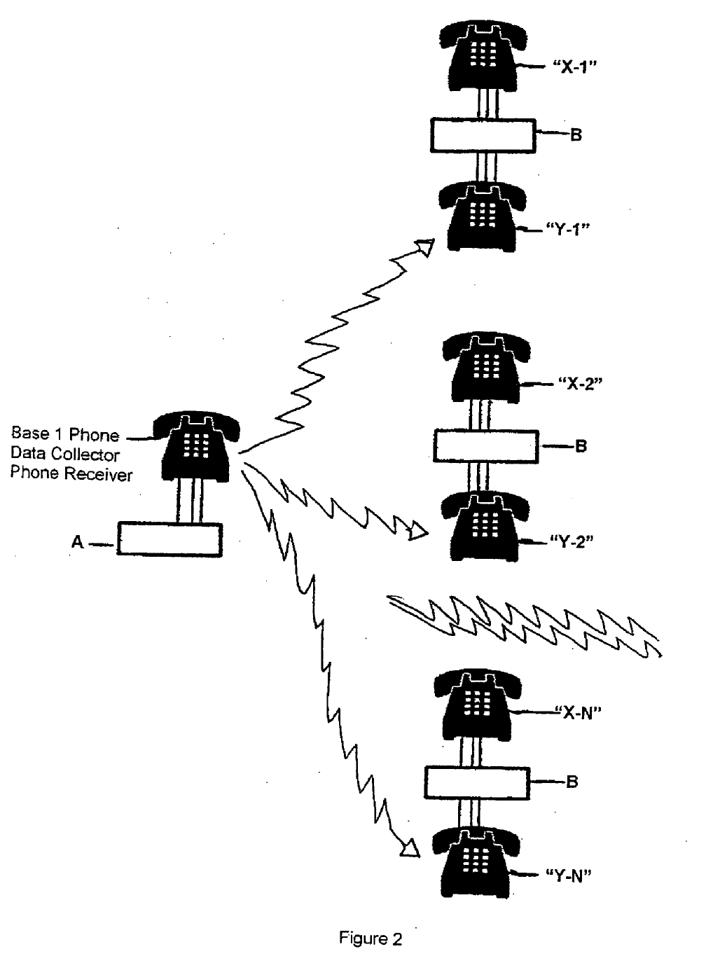

### DESCRIPTION OF THE PREFERRED EMBODIMENT

In one of its aspects the present invention is embodied in a system of remote data collection (1) upon a telephone network using (2) a base data-collector “phone” to collect data, (3) multiple remote data-transmitting “phones” each having the identical same phone number. By this arrangement a single call made by the base data-collector phone to the designated single phone number of all the remote data-transmitting phones will serve to simultaneously connect the base data-collector phone to all the remote data-transmitting phones having this same phone number.

In this system the data-collector phone is preferably possessed of (1) an auto-dialer and (2) a. fully automated data-receiving system interface that acts as the receiver of the transmitted data from each and every remote data-transmitting phone.

The remotely-situated phones serve as data transmitters, automatically communicating such data as has been automatically collected. Each data logger, telephone, or data collector—howsoever called—thus acts as a transmitter of collected data to a base data-collecting station, or phone. This communication between (1) the remotely-situated data-transmitting phones/data loggers and (1) the base data-collecting phone is preferably through the standard wireless public service telephone network.

Although the remote data-transmitting phones have the same identical phone number, each has a distinct and different identifier code. When the base data-collecting phone is in data collection mode, it first auto dials the phone number that is “common to all” the remote data-transmitting phones, thereby establishing an electronic link between itself as the base data-collecting phone and all those participating remote data-transmitting that are possessed of this primary phone number.

Once this electronic link is established, the base data-collecting phone commences to collect data seriatim from all the remote data-transmitting phones “X-I” to “X-N”, one at a time in a predetermined order,

In a preferred variant of the invention, the base data-collecting phone accurately selects a specific one remote data-transmitting phone “X-I” from the multiple available remote data-transmitting phones “X-1” to “X-N” by electronically sending an “X-I” identifier code means in common (i.e., as a broadcast signal) to all the remote data-transmitting phones “X-I” to “X-N”. However, only the unique remote data-transmitting phone that recognizes itself to be phone “X-I” will transmit collected data back to the base data-collecting phone. The interrogation of the remote phones by the base phone then proceeds seriatim. That is, the base data-collecting phone will then proceed in sequence to receive data from the remote data transmitting phone “X-2”. It does so when the base data-collecting phone electronically sends an “X-2” identifier code, again in parallel and in common, to all the remote data-transmitting phones “X-I” to “X-N”. This procedure is repeated to retrieve an entire collection of data to the base data-collecting phone from all the remaining remote data-transmitting phones “X-3” to “X-N.

Optionally, in order to increase any of the security, integrity and accuracy of the collected data to the base data-collecting phone, a distinct security code is transmitted by each of the remote data transmitting phones in conjunction with every data transmission by these remote data transmitting phones. Thus the remote data transmitting phone “X-I” will transmit a distinct security code “X-I” means as an aid to distinguish this particular remote phone and its data transmission from other remote phones. Likewise, the remote data-transmitting phone “X-2” will transmit its own distinct security code, continuing likewise for distinct security code “X-3” through-“X-N(Y).

This complete procedure is repeated by the base data collecting phone each time there is a need to collect new and/or updated data.

The base data-collecting phone disconnects its “phone call” to the multiple remote data-transmitting phones “X-1” to “X-N” once that a particular data collection cycle associated therewith is completed, Then, for a next data collection cycle, the base data-collecting phone will typically initiate another phone call to the data transmitting phones “Y-I” to “Y-N”, and the interrogation cycle is repeated continuously as needed.

In another variant embodiment of the remote data collection system and method in accordance with the present invention, the base data-collecting phone communicating with each of the remote data-transmitting phones “X-I” to “X-N” also sends command directives to these phones, For example, a specific transaction code can be sent as desired to all remote phones in common, or to any individual phone or phones as desired. By these transaction codes, or directives, the base data-collecting phone can collect specific data from each of the remote data-transmitting phone “X-I” to “X-N’. In this variant only applicable data pertaining to the specific transaction code send to each remote phone will be transmitted back to the base data-collecting phone.

In yet another variant embodiment of the present invention, the addressable remote data-transmitting phones “X-1” and “Y-1” need not be considered separate instruments, but rather as redundant communication channels to the same instrument. In this variant remote data collection might be considered to be transpiring over channels one (1) and two (2), with the addresses “Y-I” to “Y-N” being used redundantly for each and every remote data-transmitting phone “X-I” to X-N(x). This redundancy can serve as a system back-up in case of any malfunction of the primary addressing system. It can likewise be considered that a secondary phone system “Y-I” is being partnered with primary phone system “X-1”, another secondary system “Y-2” is being partnered with primary phone system “X-2” and so forth.

Now it should be recalled that this additional phone system “Y-I” to “Y-N” has a common phone number that is preferably different from the common phone number of the primary phone system “X-I” to “X-N”, but operates similarly as the primary phone system. Normally the additional phone system redundantly transmits the same identical data as does the applicable primary phone system

In this system FIG. 1 may be considered to depict a “Single Phone Linked to Multiple Phone Data Logger”—preferred embodiment of the invention.

Base 1 Phone—Data Collector Phone Receiver communicates with phones “X-1” and “X-2” through “X-N”

A represents the Automated Data Receiving System Interface.

B represents the: Automated Data Receiving System Interface.

“X-1, “X-2 to “X-N” represent Primary System Remote Phones Data Transmitters all having the same identical Primary Phone Number.

Associated “Y-1”. “Y-2” to “Y-N” represent additional System Remote Phones Data Transmitters all having the same identical Secondary Phone Number.

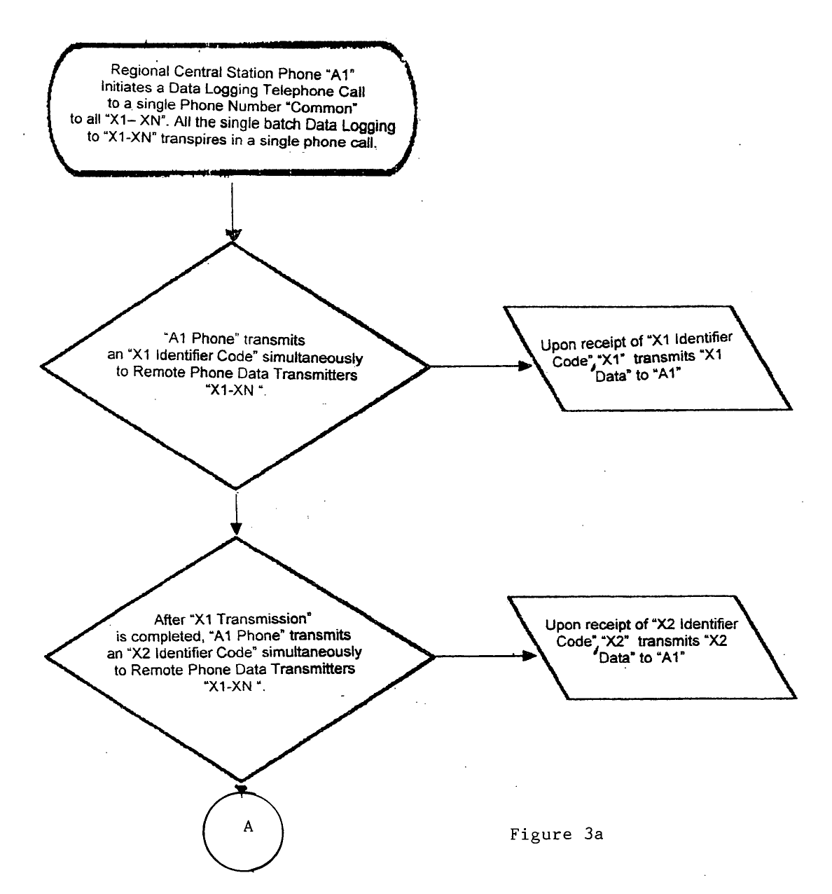

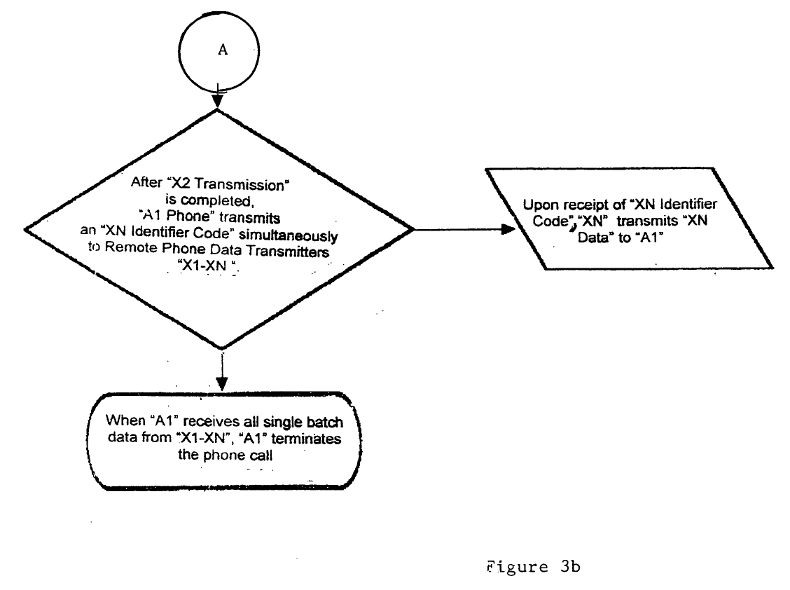

A flow chart of the operation of the addressing method of the present invention is shown in FIG. 3, consisting of FIGS. 3a and 3b. The steps of the operational flow chart of this operation of the addressing method of the present invention should be self-explanatory in consideration of the preceding explanation.

These and other aspects and attributes of the present invention make that the scope of the invention should be interpreted in accordance with the following claims, only, and not solely in accordance with that particular embodiment within which the invention has been taught.

What is claimed is:

1. A method of addressing, and retrieving data from, a multiplicity of addressable data loggers distributed on and connected by networks including the Public Service Telephone Network (PSTN), to a data-collecting central station, the method comprising:
broadcasting upon the network from the central station a primary address recognized by a plurality of network-connected data loggers; and thereafter
communicating upon the network from the central station secondary addresses sufficient to identify unique ones of the plurality of network-connected data loggers recognizing the primary address;
wherein the multiplicity of addressable data loggers are first primary-addressed and thereafter individually secondary-addressed so as to deliver up logged data to a data-collecting base station upon the network.

2. The method according to claim 1 wherein the communicating further comprises:
communicating upon the network commands sufficient to direct secondary-addressed unique ones of the plurality of primary-addressed network-connected data loggers.

3. The method according to claim 1 wherein the broadcasting comprises:
auto-dialing successively through a plurality of telephone numbers each of which numbers primary-addresses a corresponding plurality of the multiplicity of network-connected data loggers.

4. The method according to claim 1 wherein broadcasting is of a primary address that is a toll telephone number.

5. The method according to claim 1
wherein the multiplicity of addressable data loggers have call screening, and are sensitive to be first primary-addressed only by a central station having a predetermined telephone number; and
wherein the base station primary-addresses the plurality of network-connected data loggers from the predetermined telephone number.

6. A system of remote data collection upon a telephone network comprising:
multiplicity of data-collecting and data-transmitting phones upon a telephone network, where
a plurality of phones have, and are uniquely addressable by, an identical same primary phone number upon the telephone network, while
all phones of the plurality have a unique secondary identification received upon the telephone network once a phone is communicatively connected thereto and thereon, where
each operative phone when both primary-addressed and secondary-addressed transmits collected data; and
a base data-collecting phone collecting data from the multiplicity of remote data-transmitting phones by
first broadcasting a primary phone number as serves to primary-address a plurality of phones, and then, second,
successively communicating secondary identifications as successively serve to identify and to secondary-address unique phones of the primary-addressed plurality of phones, and then
successively receiving data from each unique phone of the multiplicity of phones as it is both primary-addressed and successively-secondary-addressed.

7. The system according to claim 6
operated so that when a unique phone both primary-addressed and secondary-addressed is inoperative to transmit collected data then the base data-collecting phone does in succession communicate secondary identification to a next successive phone of the primary-addressed plurality.

8. The system according to claim 6 wherein at least one of the multiplicity of data-collecting and data-transmitting phones is located accessible to an owner/operator of the base data-collecting phone without involvement any party controlling premises where is located the at least one data-collecting and data-transmitting phone.
